(19) United States
(12) Patent Application Publication
(10) Pub. No.: US 2026/0251489 A1
(43) Pub. Date: Aug. 27, 2026

(54) METHOD FOR MEASURING SLUDGE USING INFRARED TECHNOLOGY IN PETROLEUM STORAGE TANKS

(71) Applicants: Petróleo Brasileiro S.A. – Petrobras, Rio de Janeiro (BR); Fundação Centros de Referência em Tecnologias Inovadoras Santa Catarina - CERTI, Florianópolis (BR)

(72) Inventors: Erico Vieira PORTO, Rio de Janeiro (BR); Filipe FONTANA, Florianópolis (BR); Alexandre MARCONDES, Florianópolis (BR)

(21) Appl. No.: 19/543,280

(22) Filed: Feb. 18, 2026

(30) Foreign Application Priority Data
Feb. 27, 2025 (BR) 1020250038781

(51) Int. Cl. G01F 22/00; G01J 5/00; G01J 5/02; G01J 5/06; G01J 5/068; G01J 5/48

(52) U.S. Cl. CPC G01F 22/00; G01J 5/0205; G01J 5/0275; G01J 5/064; G01J 5/068; G01J 5/485; G01J 2005/0077

(57) ABSTRACT

The present disclosure relates to a method for measuring sludge using infrared technology in petroleum storage tanks, comprising: mounting a laser distance meter and an infrared camera on a tripod; positioning a metallic support plate on the tripod; positioning markers on the tank shell to serve as measurement references; configuring the infrared camera by adjusting parameters such as reflected apparent temperature, emissivity, acquisition distance, and dynamic temperature range; acquiring thermal images of the tank shell along a circular path around the tank; processing the acquired images; generating a three-dimensional representation of the sludge distribution inside the tank; and calculating the sludge volume.

### CROSS-REFERENCE

This application claims priority to Brazilian patent application Ser. No. 1020250038781, filed Feb. 27, 2025, which is incorporated herein in its entirety by reference thereto.

### FIELD

The present disclosure falls within the technical field of petroleum storage and inventory control. More specifically, it relates to petroleum storage tanks and the analysis of sludge by means of infrared image acquisition and processing of the captured images.

### BACKGROUND

The disclosure addresses the technical problem of the formation and accumulation of sludge in petroleum storage tanks. Sludge accumulation reduces the tank storage capacity, disrupts operation, and may compromise the stored product. In addition, sludge formation and accumulation is a phenomenon of great relevance, as it reduces the tank storage capacity (usable volume), may interrupt operation, and may cause the product to fall outside specification. Furthermore, sludge usually has a high saline water content which, in permanent contact with the tank bottom, accelerates the consumption of sacrificial anodes, exposing the tank to corrosive processes.

In this context, the solution achieved by the disclosure is a non-intrusive method for measuring sludge using infrared technology. This method makes it possible to quantify the sludge accumulated in the tank without interrupting its operation, enabling monitoring of the sludge volume and the planning of mitigation actions.

This measurement is carried out by collecting images of the storage tank at any time, without the need to shut it down, fill it, or drain it. Based on these images, it is possible to calculate the total volume of deposited sludge, thereby allowing better management of petroleum storage. As evidenced by the analysis of the state of the art documents, there is no similar method capable of achieving the same effect proposed by the present disclosure.

Document CN115752960A refers to a device for inspecting leak tightness and leakage points in vehicle fuel tanks. The device comprises a base plate, two fastening components, an air pump, a heating tank, a PC controller, a distribution box, an electronic pressure gauge, a solenoid valve, and an infrared camera. However, document CN115752960A is completely distant from the technical objective of the present disclosure, since it is related to the inspection of leak tightness and identification of leakage points in vehicle fuel tanks, whereas the present disclosure is related to measuring the volume of sludge in petroleum storage tanks using an infrared camera and other equipment.

Document WO2022200304A1 describes a solution for visual and sensory inspection of closed storage tanks, mentioning possible use in the petrochemical industry. This solution consists of a set of devices and methods that allow inspections to be carried out in closed tanks, even when pressurized and in potentially explosive environments. However, document WO2022200304A1 fails to describe a solution for measuring the volume of sludge in petroleum storage tanks using a combination of an infrared camera, laser distance meter, image processing software, and interpolation algorithms. The present disclosure, on the other hand, specifically focuses on the accurate measurement of sludge volume in the tank, using infrared technology and image processing to create a 3D representation of the sludge distribution inside the tank.

The article entitled “SLUDGE INTERFACE MEASUREMENT IN THE STORAGE TANK UTILIZING NEUTRON BACKSCATTERING TECHNIQUE: A FIELD EXPERIMENT,” published in 2023, describes a technique for inspecting sludge level in crude oil storage tanks using the neutron backscattering technique. This technique involves the use of a neutron scanning system that includes a neutron emitter, a neutron detector, a rate counter, a winch for scanner movement, and a computer for data processing. While the present disclosure focuses on the use of technologies such as infrared cameras and laser distance meters for visual and sensory inspection of storage tanks, the article describes a different technique that uses neutron backscattering to detect mud levels in crude oil storage tanks, which is a more costly technique and not very feasible for large-scale application, as it also requires draining the petroleum tank.

Document CN116543124A describes a method for identifying and evaluating sludge content in petroleum storage tanks based on images, being considered the closest prior art. However, document CN116543124A fails to present a suitable solution for very large tanks, yielding poorer results when applied to the same scenario as the present disclosure. In addition, it does not establish a methodology for complete coverage of the tank surface evaluated in the document itself. Moreover, there is no discussion in the document that assists in establishing parameters for the image capture steps and the use of references for future processing, ensuring that the tank surface is faithfully represented.

Thus, unlike the state of the art documents, the present disclosure proposes a method for measuring sludge in large petroleum storage tanks. Specifically, the disclosure uses infrared technology through thermographic image capture of the shell to measure sludge levels below 1 meter in height in tanks with diameters greater than 75 meters.

### BRIEF SUMMARY

The present disclosure relates to a method for measuring sludge in petroleum storage tanks using infrared technology, allowing quantification of the accumulated sludge without interrupting tank operation. The method involves capturing images of the interior of the tank and applying image processing algorithms to generate an accurate estimate of the sludge volume.

### BRIEF DESCRIPTION OF THE DRAWINGS

The present disclosure will be described below with reference to the typical embodiments thereof and also with reference to the attached drawings, wherein:

FIG. 1 is a representation of thermographic images of the tank surface showing temperature variations between petroleum and sludge, according to an embodiment of the present disclosure.

FIG. 2 is a representation of an inverted cylindrical panorama of the tank, stitched from the acquired thermal images, according to an embodiment of the present disclosure.

FIG. 3 is a representation of a three-dimensional cylinder of the sludge distribution inside the tank, projected from the marked sludge points, according to an embodiment of the present disclosure.

FIG. 4 is a flattened representation of the three-dimensional cylinder, indicating regions of sludge accumulation, according to an embodiment of the present disclosure.

### DETAILED DESCRIPTION

The method for measuring sludge in petroleum storage tanks, as described in this disclosure, involves the use of a combination of infrared cameras, laser distance meters, and image processing software to measure, calculate, and monitor sludge volume without the need to interrupt tank operations.

The process begins with the installation of infrared cameras and laser distance meters on the storage tank. The infrared cameras are positioned at strategic points around the tank, typically on the shell and at the top of the tank, to capture a broad view of the internal surface. Depending on the size of the tank, it may be necessary to install multiple cameras to cover the entire area. The laser distance meters are placed at predetermined measurement points to ensure accurate data collection regarding sludge height at various locations in the tank.

The infrared cameras are calibrated to detect temperature differences between the stored petroleum and the sludge, since both have distinct thermal properties. The sludge, composed of sedimentary particles, water, and residual oil, exhibits a different thermal signature from the more fluid petroleum, which facilitates its visual detection in the captured images. The laser distance meters, in turn, are configured to perform distance and sludge height measurements relative to the tank bottom.

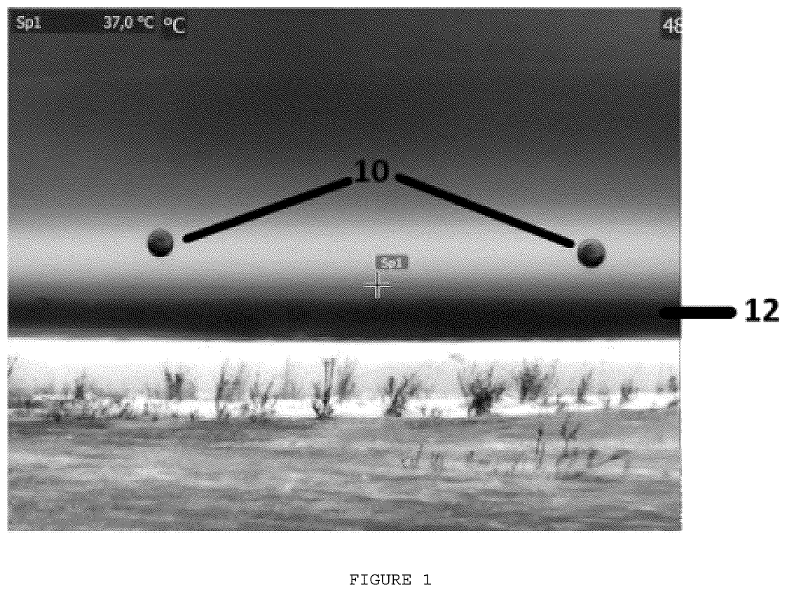

With the equipment installed and calibrated, the data acquisition phase begins. The infrared cameras perform periodic scans of the tank, recording thermographic images of the surface, as shown in FIG. 1. These images clearly show temperature variations between the petroleum and the sludge 12, in relation to the markers 10, facilitating identification of areas where sediment accumulation occurs.

Simultaneously, the laser distance meters perform three-dimensional measurements of the sludge surface. They emit laser pulses toward the tank bottom and measure the time taken for the beam to return, thereby calculating the height of the sedimented material. This process is repeated at different points in the tank, generating a three-dimensional map of sludge distribution.

The infrared images and laser measurements are sent to image processing software. This software is responsible for analyzing and processing the collected images and data, identifying regions where sludge has accumulated. The thermographic images captured by the cameras are automatically segmented by the software, which distinguishes sludge areas based on temperature differences relative to the surrounding petroleum.

The software uses advanced image processing algorithms to generate a three-dimensional representation of the sludge inside the tank. This visualization allows operators to clearly understand the distribution and volume of accumulated sludge in each region. The laser measurements are integrated with the image data to increase the accuracy of the volumetric estimate, providing additional data on sludge thickness at specific points.

In addition, the software uses interpolation algorithms to calculate the total sludge volume in the tank. These interpolations are especially useful for estimating sludge volume in areas where visibility from the infrared cameras may be limited, or where laser measurements cannot directly cover. The software combines these data to ensure accurate and comprehensive measurement.

Once the data are processed, the software generates detailed reports that include a three-dimensional graphical representation of the sludge in the tank, as well as numerical estimates of the total volume. These reports are stored in a management system, where they can be analyzed by operators to plan corrective actions, such as sludge removal or preventive maintenance.

The method allows monitoring to be performed continuously or periodically, according to operational needs. The infrared cameras can be programmed to perform automatic scans at regular intervals, while the laser distance meters continue measuring sludge height at pre-established points. This ensures that any unexpected sludge accumulation is detected quickly, allowing necessary measures to be taken before tank operation is compromised.

More specifically, the present disclosure proposes a method for measuring sludge using infrared technology in petroleum storage tanks, comprising:
mounting a laser distance meter and an infrared camera on a tripod;
positioning a metallic support plate on the tripod;
positioning markers on the tank shell to serve as measurement references;
configuring the infrared camera, adjusting parameters such as reflected apparent temperature, emissivity, acquisition distance, and dynamic temperature range;
acquiring thermal images of the tank shell along a circular path around the tank;
processing the acquired images;
generating a three-dimensional representation of the sludge distribution inside the tank; and
calculating the sludge volume.

The configuration of the infrared camera includes adjusting ambient temperature and relative humidity; setting the reflected apparent temperature to 90% of the ambient temperature; defining an emissivity of 0.95; configuring the image acquisition distance between 10 and 15 meters from the tank; adjusting the dynamic temperature range for image acquisition; and configuring the camera for “single shot” image acquisition (one image per trigger).

In addition, the markers are positioned on the tank shell, wherein the first marker is positioned to the right side of the tank product inlet/outlet piping; the markers are placed below a black band on the shell and at a distance that allows visualization of only two markers per image; and the markers are not moved during image acquisition to ensure correlation between them.

In this sense, the distance between two subsequent markers follows the following relationship:

$$distance ≅ \frac{FOV \times DST \times ( 1 - OVP ) \times ( 2 DST + \frac{DIA}{DIA} ) \times DIA}{( 2 DST + DIA )}$$

wherein DST represents the distance between the camera and the tank, DIA represents the tank diameter, FOV represents the camera field of view, and OVP represents the overlap between images.

The thermal image acquisition step is carried out continuously, in a counterclockwise direction around the tank, until the marker from the first image is recorded again, completing a full rotation around the tank. The distance between the camera and the tank is kept constant using the laser distance meter, ensuring a 30% overlap between adjacent images.

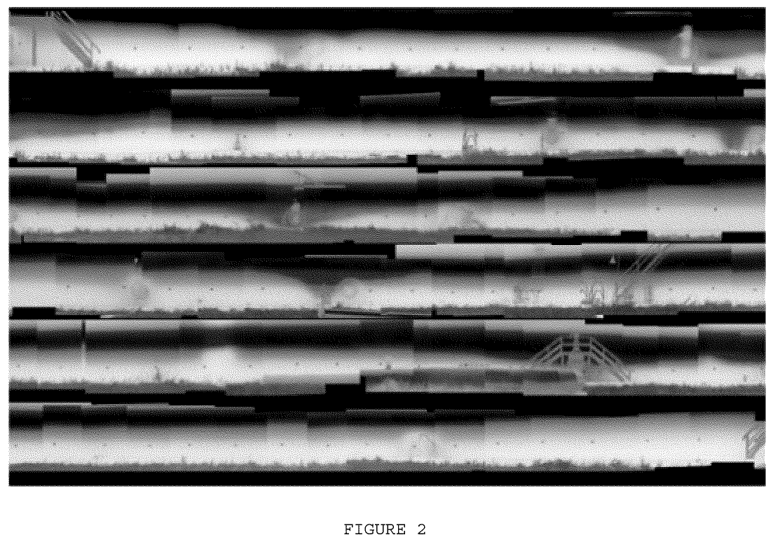

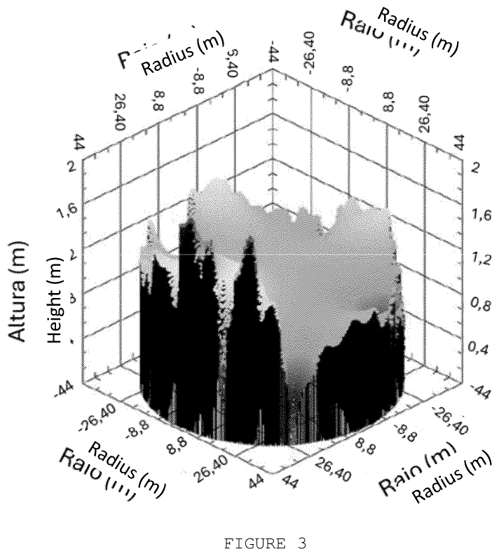

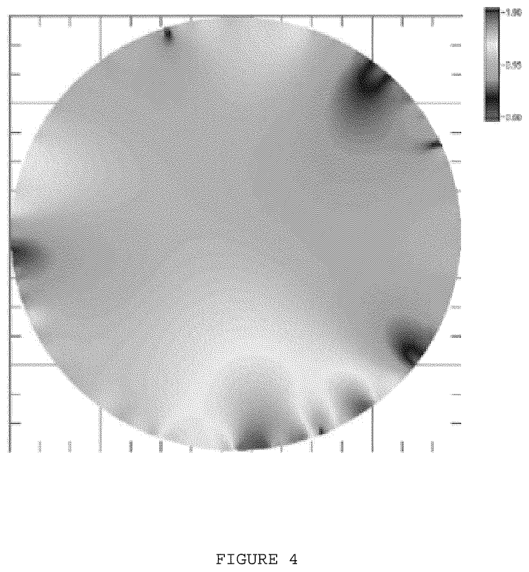

The step of processing the thermal images comprises stitching the images into an inverted cylindrical panorama, as shown in FIG. 2. Next, the step of generating a three-dimensional representation of the sludge distribution inside the tank comprises unrolling the inverted cylindrical panorama into a long rectangular image; marking the fractions corresponding to sludge into sludge points; and projecting the sludge points onto a 3D cylinder, as represented in FIG. 3. The interior of the cylinder is reconstructed using the kriging technique to interpolate the points inside the tank. In addition, a flattened view of the cylinder is provided, indicating regions of sludge accumulation, as represented in FIG. 4.

This type of monitoring can be easily integrated into inventory management systems or quality control platforms used by the storage facility. This allows sludge data to be cross-referenced with information on stored petroleum volume, product quality, and tank operating history. In this way, operators can more accurately predict when sludge will reach critical levels, enabling the planning of interventions before accumulation affects the usable capacity of the tank.

The proposed method has the advantage of being non-intrusive, eliminating the need to shut down the tank or drain the petroleum to perform the measurements. By monitoring sludge in real time and without interrupting operations, the disclosure provides an efficient and economical way to maximize storage capacity and minimize operational costs associated with cleaning and maintenance.

The method was developed to be applicable to large tanks, such as those found in refineries and storage terminals, which may have diameters greater than 75 meters. The ability to accurately monitor sludge in large tanks represents a significant advancement over conventional techniques, which often fail to fully cover such extensive areas. With the present disclosure, accurate measurement of sludge in large tanks is possible, providing comprehensive monitoring of the integrity of the tank and its contents.

In summary, the described method is capable of providing accurate and efficient measurement of sludge accumulated in petroleum storage tanks. By combining infrared cameras, laser distance meters, and advanced image processing, the method offers a solution for waste management, optimizing tank usage and ensuring continuity of operations without unnecessary interruptions.

1. A method for measuring sludge using infrared technology in petroleum storage tanks, comprising:
mounting a laser distance meter and an infrared camera on a tripod;
positioning a metallic support plate on the tripod;
positioning markers on a tank shell of a tank to serve as a measurement reference;
configuring the infrared camera;
acquiring thermal images of the tank shell along a circular path around the tank;
processing the acquired images;
generating a three-dimensional representation of the sludge distribution inside the tank; and
calculating the sludge volume.

2. The method of claim 1, wherein the configuring the infrared camera includes:
adjusting an ambient temperature and a relative humidity;
configuring a reflected apparent temperature as 90% of the ambient temperature;
defining an emissivity range;
configuring an image acquisition distance between 10 and 15 meters from the tank;
adjusting a dynamic temperature range for image acquisition;
configuring the infrared camera for single shot image acquisition such that the infrared camera captures one image per trigger;
adjusting the infrared camera focus to ensure sharpness of the tank shell image;
defining a minimum thermal sensitivity of 0.04° C. in the temperature range of 0° C. to 40° C.; and
defining a minimum camera resolution of 640×480 pixels.

3. The method of claim 1, wherein positioning the markers on the tank shell comprises:
positioning a first marker is on the right side of the tank product inlet/outlet piping;
wherein the markers are placed below a black band on the shell; and
wherein the markers are not moved during image acquisition to ensure correlation between them.

4. The method of claim 1, wherein the distance between two subsequent markers follows the relationship
$$distance ≅ \frac{FOV \times DST \times ( 1 - OVP ) \times ( 2 DST + \frac{DIA}{DIA} ) \times DIA}{( 2 DST + DIA )}$$
wherein:
DST represents the distance between the camera and the tank;
DIA represents the tank diameter;
FOV represents the camera field of view; and
OVP represents the overlap between images.

5. The method of claim 1, wherein the acquiring thermal images step is carried out continuously, in a counterclockwise direction around the tank, until a marker from a first thermal image is recorded again, completing a full rotation around the tank.

6. The method of claim 1, wherein the distance between the camera and the tank is kept constant using the laser distance meter.

7. The method of claim 1, wherein the step of processing the acquired images comprises stitching the acquired images into an inverted cylindrical panorama.

8. The method of claim 1, wherein the step of generating a three-dimensional representation of the sludge distribution inside the tank comprises:
unrolling the inverted cylindrical panorama into a long rectangular image;
marking the fractions corresponding to sludge into sludge points; and
projecting the sludge points onto a 3D cylinder.

9. The method of claim 8, wherein an interior of the cylinder is reconstructed using a kriging technique to interpolate points inside the tank.

10. The method of claim 1, wherein the method for measuring sludge is performed while the tank is in operation.
